(19) United States
(12) Patent Application Publication
(10) Pub. No.: US 2008/0025910 A1
(43) Pub. Date: Jan. 31, 2008

(54) Process to make both nitric and sulfuric acid

(76) Inventor: Robert Neville O'Brien, Victoria (CA)

Correspondence Address: Robert Neville O'Brien, 2614 Queenswood Dr., Victoria, BC, V8N 1X5, US

(21) Appl. No.: 11/493,299

(22) Filed: Jul. 27, 2006

(51) Int. Cl. C01B 17/82

(52) U.S. Cl. 423/523; 423/393

(57) ABSTRACT

Stirred acid resistant shallow cylindrical reactors are used to produce both nitric and sulfuric acid from a feed gas stream arranged to contain both sulfur dioxide and nitrogen oxides passed over or through the mixed acids. The homogeneous catalytic mixture of sulfuric and nitric acids uses the highly oxidizing nitrosyl ion to further oxidize the gaseous oxide stream to sulfuric and nitric acids. Oxygen or air then oxidizes the nitrosyl ion reduction products back to nitrosyl ion for further reaction. The acids are separated by distillation, and concentrated using heat from the burner and the reaction heat. The modified sulfur burner used operates at temperatures to oxidize some of the nitrogen in the air. The temperature required may be obtained by increasing the oxygen of the air by pure oxygen. More nitrogen oxides may be produced by a glow discharge into the burner air or burning of ammonia. Any heavy metals such as mercury will be first oxidized then precipitated as sulfates.

### BACKGROUND OF THE INVENTION

1. Technical Field

In general, this invention relates to the herinafter described homogeneously catalyzed process for the simultaneously making of both sulfuric acid and nitric acid from flue gases generated by high temperature burning of various substances such as coal in a utility plant, solid or liquefied sulfur, nitrogenous waste containing also sulfur compounds and with the possible addition of a glow discharge or burning of ammonia as will be detailed below.

The process can be generally regarded as anti-pollutant in some of its aspects where both SO2 and NOx can be removed from flue gases, and when heavy metal vapours are present, those also can be removed.

2. Related Art

McIntyre et al in U.S. Pat. No. 4,619,608 for a PROCESS FOR REMOVAL OF POLLUTANTS FROM WASTE GAS EMISSIONS have recognized, as they said in a back-ground related remark, that “Generally, the wet scrubbing methods, especially the methods using aqueous oxidizing solutions are the only systems readily useable for the simultaneous removal of NO.sub.x and SO.sub.2” However, nothing to my knowledge in connection with conventional “wet scrubbing” methods for purifying stack gases from any type of furnace or burner come closer in conception and structure to the present invention than have the three of my own, previously patented, inventions which are next identified, as they were also in a provisional application, #60/782,226 (Mar. 15, 2006)

The three patents are U.S. Pat. No. 5,681,540 for a PROCESS FOR THE RECOVERY OF SULFUR FROM A FEEDSTOCK; U.S. Pat. No. 5,788,949 for LIQUID PHASE CONVERSION OF A SOURCE OF SULFUR DIOXIDE TO SULFURIC ACID; and, U.S. Pat. No. 6,284,212 B1 for a METHOD OF NITRIC ACID FORMATION USING A CATALYTIC SOLUTION—all by me, Robert Neville O'Brien. Important similaritities, divergences and distinctions are evident amongst these three separately patented inventions. Their semblance and similarity is due chiefly to my using in each the oxidizing agent nitrosyl ion formed from a mixture of sulfuric and nitric acid in aqueous solution, the nitrosyl ion reduction products to be reoxidized by the oxygen in the bubbles of feed gas, whether in air or added as technical grade oxygen. The treated gas phase feed stocks are of various compositions from various sources, and the treatments are each operated at different conditions to achieve different results.

Following the immediately above paragraph, the present invention requires review of the already granted patents to show what is new in this invention.

In U.S. Pat. No. 5,681,540 I expressly taught a process intended to cause precipitation of solid phase elemental sulfur from the mixed acid solutions, and to be able to vary the amount of sulfur appearing on nitrosyl ion treatment of the feed gas as elemental sulfur or sulfuric acid as product by manipulating the temperature of the reaction. Quite differently, even though using a similar solution, my sulfuric acid making process in U.S. Pat. No. 5,788,949 clearly “avoids the formation of elemental sulfur, so that in designing the conversion towers, there is no consideration required for handling of solids.” The fact of this divergence shows the impossibility of drawing—merely from the shared fact of using similar mixed acids—any conclusions as to whether or not solid phase sulfur would necessarily always be produced.

In the reactor columns, that are bubble tray columns, described in the last two patents (second and third as cited above), both are specifically acid making only. U.S. Pat. No. 5,788,949 includes a drawing which shows a reactor (called a “mass transfer column”) that has a conduit for removal of gases from above the top tray in a series of perforated trays in the column. A similar multi-trayed bubble cap column, or “reactor” for making nitric acid in U.S. Pat. No. 6,284,212 B1, however, has no provision for top-mounted gas removal such as the sulfuric acid making invention has. Instead, I made it clear in the nitric acid-making patent that the “outflow specifically [from the reactor] is substantially confined to liquid phase material”—meaning no gas phase effluent to handle, further made clear by teaching “—all gas bubbled into that particular body is consumed in reactions in the solution when oxygen is present”, in the stoichiometric requirement of the reaction. If air is used, the un-oxidized nitrogen passes through to be vented, countercurrent to the incoming gas stream before the burners and other parts of the process, then as cooled, vented to atmosphere or compressed for storage and sale. It should be said that thermal conservation would undoubtedly be used extensively in the practice of this invention, only some of which will be mentioned when such conservation is clearly needed.

There was also a divergence in thermal condition required in these two patents. In my U.S. Pat. No. 5,788,949 (sulfuric acid) invention, I taught that “when conducting the conversion in a tower, it is preferred to have a temperature at the bottom in the range of 130 degrees Celcius to 150 C so as to denitrify the concentrate.” Which means to boil off the nitric acid, expected to be the water azeotrope, and provide a sulfuric acid concentrate suitable for concentration further by distillation. I said “within this range of temperatures it would also be possible to provide a concentrated sulfuric acid at the bottom of the tower that is devoid of NOx because of this hot zone at the base of the tower should leave the H2SO4 solution free of any nitrogen compounds.” Clearly, in a multi-trayed tower there must be a divergence of temperatures, rising towards the bottom of the column. In the nitric acid formation patent (U.S. Pat. No. 6,284,212 B1) the bottom of the reactor temperature must not be so high as to “boil off” the HNO3 azeotrope and about 80 degrees Celcius is a suitable temperature for an all liquid effluent at the top when oxygen rather than air is used to re-oxidize the nitrosyl ion reduction products.

I believe these differences, delineated above, are sufficient to show that this is a new invention, although it uses the same homogeneous catalyst. Indeed many previously or presently patented processes using different feed streams producing different products use the same catalyst such as platinum, or others of the triad of catalytic elements in the Periodic Table of Elements, and are easily recognized as different inventions.

Although there is some likelihood that some competent workers in the field would suggest that a bubble of pure reactants as opposed to a bubble containing “inert” gases may react at markedly different speeds, one only has to consider the size of the bubbles, which are observed to be between two and three millimeters in diameter, and calculate, using the known gas diffusion rates and the gas laws, the rate of presentation of the reacting gas at the gas liquid interface. It is true that the diffusion must be essentially a random walk and that this means the mean free path will be shorter with inerts present, but the theoretical factor is of the order of 5 times slower, and the calculation below is not then altered by an order of magnitude. The calculated average time of translation from the centre of a bubble is of the order of microseconds. The rate of reaction in the liquid at the concentrations used would be even more rapid, that is the oxidation of the NOx and the SO2 followed by the re-oxidation of the reduction products of the nitrosyl ion to nitrosyl ion for a further reaction with the bubble constituents, considering that the reaction occurs within about 20 diffusion “jumps” in the liquid using cage theory of solution. For the sulfuric acid process (U.S. Pat. No. 5,788,949) the sulfur dioxide is quite soluble and so the rate of diffusion in of SO2 and H2SO4 out is not a problem. The nitrogen oxides consist of some soluble oxides such as NO2, but mainly of NO which is only slightly soluble. But in the experimental runs with a one litre laboratory pilot plant, the rate of formation of HNO3 was ⅔ that of H2SO4 as predicted by stoichiometry which requires that the availability of the requisite gas in the feed gas is not limiting nor is the NOx in the oxidizing solution. The rising bubbles are well known to cause rapid convection at their surfaces and hence renewal at very rapid rates of available reactants at the bubble surface. Experiments in smooth, square, vertical glass tubes were video taped and showed complete reaction within less than 10 cm of rise of the bubbles in this reaction mixture. Hatta numbers calculated from these experiments showed values above 100, or calculations of the rapidity of the reaction immediately above are probably conservative and well below actual bubble cap reactor rates.

It seems pertinent to further note that whereas U.S. Pat. No. 5,788,949 (sulfuric acid) contained remarks dealing with gases exhausted from the claimed process itself, which could even include lost nitric acid vapour, my more recently issued U.S. Pat. No. 6,284,212 B1 (nitric acid) did not have to contend with the same issue, for the reason alluded to above, that is that there was to be no off-gassing from the liquid phase at any level in a reactor column, except as noted in paragraph [0007] above, the use of air as the overall oxidant. The sum of what is believed to be a complex series of primary reactions is that this is a homogeneously catalyzed, further oxidation by oxygen, of sulfur and nitrogen oxides and precipitation of heavy metals as sulfates.

### BRIEF SUMMARY OF THE INVENTION

In place of the column reactor described in the three cited patents, the reaction vessel in this invention is the stirred reactor, only briefly referred to in the previous sulfuric acid patent (U.S. Pat. No. 5,788,949); the object being to remove the difficulty of extracting heat of reaction from a column reactor of many bubble trays and to produce an equivalent or larger gas-liquid reaction interface. These bubble trays and any heat absorbing and removing apparatus must be either glass or Teflon covered to avoid rapid corrosion by the hot mixed acids which must be monitored by frequent analysis for iron, chromium and nickel to alert the operator that there is a coating failure in the process apparatus structure. Another important object of this invention is to teach a method using a liquid phase comprising combined nitric and sulfuric acid to homogeneously catalyze a reaction producing more nitric and sulfuric acid for storage and sale from a stream of feed gas derived in various ways from oxidation of a variety of substrates which is thus further oxidized by oxygen. These include, but are not restricted to, stack gases from various industries such as coal-fired utility plants where at temperatures of combustion maintained to get complete oxidation of carbon in the coal, some of nitrogen in the air is converted to NOx, and with SO2 from sulfur contained in the coal must be “scrubbed” and in the case of this invention “wet scrubbed”. Other processes where the invention applies is in incineration of a city's waste where any heavy metal oxides or vapours will be precipitated as sulfates. The “mining” of city dumps for burnable gas has begun. It usually contains much valuable fuel but also sulfur and nitrogen containing gases which this invention could turn into saleable products. Manure from pig farms, feed lots, meat and fish processing plants have been targeted for odours. Liquid scrubbing of the burner off gases using these as fuel could alleviate this perceived nuisance. In some cases, there may not be enough sulfur or nitrogen in the produced gases to give the desired mixed acid product for commercially viable separation of the two acids. Some sulfur or ammonia could be burned and the heat and gases added to the feed gas to give the desired acid mixture product. Nitrogen from the air can be oxidized to NOx by a glow discharge similar to the old Berkland-Eyde process, just prior to immersion in the scrub liquid. The most commonly used process in nitric acid production currently is the burning of ammonia. A side stream added from an ammonia burner could be used and would contribute extra heat to the main burner as well as NOx. A series of experiments following the issue of the three patents cited was done in a one litre laboratory pilot plant which was a stirred reactor. For sulfuric acid, the results showed that one cubic meter of stirred reactor could produce 27 tonnes of sulfuric acid per day. When the pilot plant was used for nitric acid production ⅔ of 27 or 18 tonnes of nitric acid would be produced which was interpreted to mean that since the ratio was correct for the two reactions that the maximum reaction rate had not been reached since it unlikely that sulfur dioxide oxidation to sulfuric acid and nitrogen oxides to nitric that the rate of the two reactions would be identical. These results led ultimately to the refinements embodied in this application.

Mercury is ubiquitous in ore bodies and has been used with a mercury vapour “sniffer” to discover metal ore deposits, especially base metals such as copper and zinc ores, but it also occurs in thermal coal. Other metal oxides, ions or vapours other than the alkali metal ones which are soluble and not usually objectionable, will be multivalent and un-wanted in the environment. They will usually be present in sulfuric acid solutions as two-to-two valent salts or of even higher valence states in the process and be much less soluble than less highly charged salts as their concentration builds up and the sulfuric acid concentration increases from start-up to give common ion effect to speed sulfate salt precipitation. Precipitation of these un-wanted solids into the bottom of a stirred reactor is not a source of blockage of the reaction vessel as they will be easily swept to a simple drain and exterior filter to allow their elimination and the return of any liquid to the reactor which may be invoked at regular intervals.

Many of the gas streams that might be treated contain gases such as nitrogen, carbon dioxide and carbon monoxide and the rare gas argon to name a few of the “passenger” or non-reactive species likely to be present. Some, such as carbon monoxide have been measured to be slightly reduced on being oxidized to carbon dioxide but not eliminated if present in as much as one percent. It is important to note again that the effective targets of the mixed acids are sulfur dioxide, nitrogen oxides and metal vapours such as mercury.

The invention requires that the incoming gas from whatever source of sulfur dioxide and nitrogen oxides, must be cooled to about 80 degrees Celcius. Most of the undesired metals, elemental vapours or oxides will be removed from the gas stream at this temperature. Of the expected metals only mercury will still be present as a very dilute vapour for reaction with the catalytic mixture of acids. The solid metal oxides or other solids should be filtered, but in the stirred reactor of this invention compared to multi-tiered reactors of previous inventions, they can be safely and easily removed at intervals as outlined above.

In the stirred reactor of this invention, the conventional counter flow of reactants is practiced, that is the gas flows into the space between the catalytic mixture and the sealed capping device in the opposite direction to stirring. The liquid is stirred in the normal magnetic stirring system clockwise to interact with the gas stream, entering counter clockwise assymtotic to the wall of the shallow cylindrical reactor, or alternatively the gas feed stock is introduced at the bottom of the stirred reactor from a perforated coil of Teflon tubing of the appropriate internal diameter. Because the feed stock gases can be expected to have some solids as fly ash the hole size in the coil must be large and for continuous production, there must be inlet fittings that permit two coils to be attached at once so that one may be cleaned of solids while the other continues to bubble in the target gases. This is the preferred reactor gas inlet arrangement despite the easier removal of precipitated solids when a bubbler is fitted rather than the perforated coils. As cited above, laboratory work showed that introduced bubbles are denuded of reactor molecules in less than 10 cm, or slightly more than 10 cm of water pressure is needed to introduce the gas by the perforated tube. This is much less than the pressure required to operate either a packed column reactor or a bubble tray column reactor which is of the order of ½ to ¼ of and atmosphere as opposed to 20 cm of water, ˜0.045 atm., thus lowering pumping requirements, and at a much lower capital cost, especially if the batch mode is used as detailed below. Preferred dimensions are from 0.5 to one metre in diameter and 15 to 20 cm deep.

As noted above [0012], the mixed acids and the resulting nitrosyl ion are highly oxidizing. The stirred reactor must be either glass or Teflon lined steel to avoid use of costly resistant metals such as tantalum. The technology to glass coat steel is well known as is coating with Teflon such as in cookware. Fittings needed for inlets and outlets for both glass and Teflon are available and leak-proof.

There is some evidence that at least part of the market for these two mixed acids does not require their separation. In the process of making fertilizer from mined phosphate rock, sulfuric acid is used to make a form of phosphoric acid for reacting with, in some cases, lime stone, or ammonia etc. to make several forms of solid fertilizer. The presence of nitric acid when ammonia is added would give a very rich in nitrogen fertilizer, such as ammonium nitrate and ammonium phosphate. The reaction ideally produces two mol of nitric for every three mol of sulfuric acid, which is likely close to the requirements of this industry. The exact method of using the mixed acid to the best advantage is left to the fertilizer manufacturers.

Turning to the diagrams designated 1A and 1B, 1A is a schematic showing the gas inlet allowing extra oxygen to be added if required and also more nitrogen oxides from a glow discharge or an ammonia burner if more NOx is required to make the feed gas acceptable and able to make both acids in useful quantities. The side inlet also allows more sulfur dioxide to be added if needed. This is the preferred inlet arrangement and makes allowance for substitution of the source material so that on oxidation it would produce the desired feed gas stream with the simplest arrangement of gas ingress. The drawing 1B does not show the mixing arrangements in the feed gas stream, but shows the more desirable perforated Teflon ring for introduction of the gas stream. Not shown is that perforations are on the bottom of the ring which is supported about two cm above the bottom of the reactor so that a special brush can remove any solids emitted due to heavy metals in the substrate burned, and which might also choke the perforations.

On mixing the acids, nitrosyl sulfuric acid is formed, which then dissociates to form nitrosyl ion and bisulfate ion. At the gas interface, whether made by bubbles as in the previous patents and originally in the laboratory bubble disappearance experiments, or by passing the gas at high speed counter current to a rapidly stirred catalytic acid mixture, or introducing the gas by a perorated ring, a high Hatta number succession of oxidations and reductions occurs in the gas liquid interface, but mainly on the liquid side and within a few molecular diameters from the interface. Normally an incubation period occurs of the order of a few minutes before the issuing gas stream contains no measurable sulfur dioxide or nitrogen oxides. For continuous operation this occurs once, but small installations using an intermittent batch system, recycling of the un-reacted gas is easily arranged to give no noxius gas emissions.

A brief description of the drawings of the two figures of the drawings follows, followed by a detailed description of the invention.

### BRIEF DESCRIPTION OF THE DRAWINGS

FIG. 1A is a concept drawing of the mode of entry and mixing of the feed stream gases not showing thermal recycling or the burners necessary, but showing the lined stirred reactor and the simplest method of obtaining a massive, reactive, gas-solution interface that will normally exceed bubble cap towers in either of the entrance modes, free gas stream or perforated coil.

FIG. 1B shows the preferred method of contacting the feed gas with the oxidizing mixed acids in the stirred reactor using a perforated ring bubbler and rapid stirring.

### DETAILED DESCRIPTION OF THE ILLUSTRATED EMBODIMENT

In the drawing 1A, 1 is the inlet of the burner gasses after cooling to 80 degrees Celcius during which major fly-ash and other particles resulting from the burning of solids will have dropped out. Extra oxygen or air has a separate inlet 2, and 3 is an optional inlet for NOx made by burning ammonia or by a glow discharge which also adds oxygen not used to make NOx as the gasses proceed to the flow meters 4 to provide the data to control the flow of the various gas streams to the mixing chamber 5 just prior to entering the stirred reactor 8 containing the mixed acids 6 by the inlet pipe 7. A gas outlet 15 when air rather than pure oxygen is used leads to a sampler, not shown but necessary in batch mode, with recycle to the inlet 7, also not shown. Additions to the burner gas stream 1, may be necessary to obtain a mixture that produces economical and usable quantities of the two acids which is especially so for nitric which is at least twice as valuable as sulfuric.

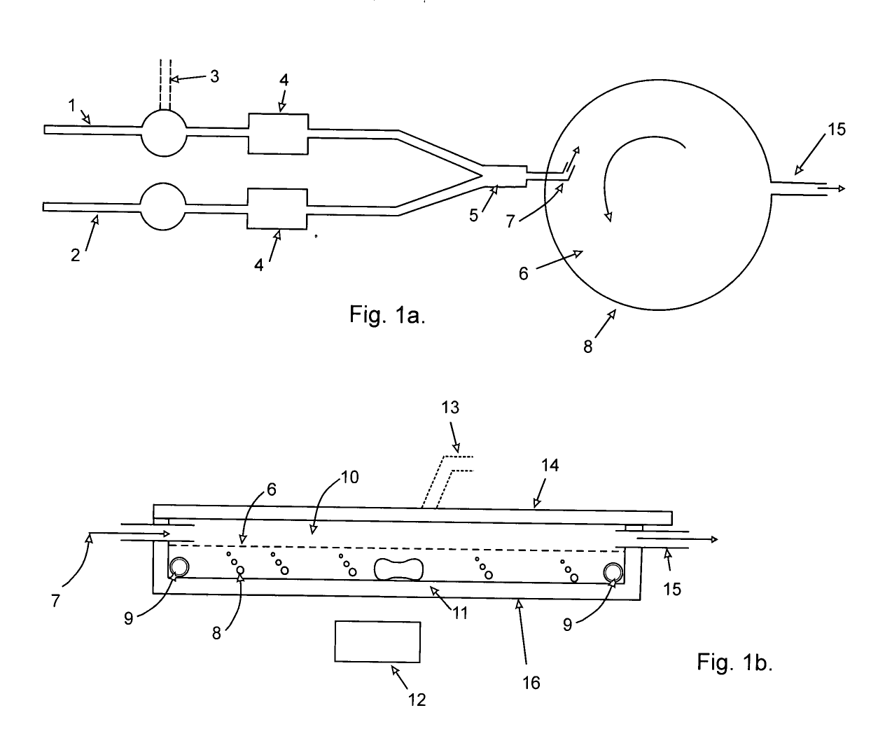

FIG. 1A is the simplest, effective form of the invention and the cheapest used in the batch mode. It is expected that it will dominate small batch applications of the invention in such uses as for small mining operations, shut in sour gas wells, small town garbage incinerators or any small incineration operation where intermittent operation is the norm and where ejected small amounts of the un-reacted feed gas are tolerable making collection and sale of nitrogen impractical.

The gas inlet 7 provides the cooled gas feed stream, balanced as needed from data from flow meters 4 relayed to a small computer which will operate control valves, not shown, on the various parts of the feed stream. The pressure to get a sufficiently rapid flow of gas assymtotic to the wall of the lined shallow cylindrical reaction vessel will be of the order of 5 to 10 inches of water above ambient, provided by a centrifugal Teflon gas pump, not shown, following cooling and mixing of the gas stream. This pump will usually not be necessary as presentation of the original gases [or a pulverized solid] to the burners will have required some pressure. The pressure drop on cooling of the burner gases could easily be acquired initially by calculation and refined by experience to allow a back up pump if needed to supply the required pressure.

The gas discharged between the liquid surface and the cover (shown only in 1B, 14) would be expected to be turbulent, or above the Reynolds Number as it passes through a space between the sealed cover and the rapidly stirred mixed acids in the reactor 8, in counter-current flow. The reacting gas will decrease in volume, especially if pure oxygen is used in the burners, and as the SO2 and NOx react. The residual gas stream will slow down because of friction such as interaction with the catalytic solution surface and the cover as it moves towards the greater gap between the gas and the liquid 6 at the centre. The “stripped” gas is expected to be mainly nitrogen especially if air is used as the oxidizer of the nitrosyl ion reduction product back to nitrosyl ion. There are two alternative gas outlets 13 and 15, but only 15 is shown in FIG. 1A. The gas outlet 15 in FIG. 1A, presumes a rapid stripping of the feed stream gas when placed opposite of the inlet 7, though it could be placed just behind the inlet gas elbow 7 or in the centre of the cover.

Two effects other than absorption and reaction, cause the gas flow to reduce the radius of its initial direction assymtotic to the reactor's wall 8. The rapid stirring of the catalytic acid mixture will cause the meniscus to climb up the reactor's wall and decrease the distance between the cover 14 and the liquid. The centre of rotation will then be lower, affording more space for gas.

The second factor is that the interfacial friction at the gas-liquid interface and the interaction with the curved wall and cover 14 of the reactor 8 will reduce the velocity of the gas, reducing its momentum to maintain straight line translation. Again this suggests that the stripped gas outlet 13 in 1B is the more appropriate. However, the arrangement in FIG. 1A is that used effectively in a one litre pilot plant apparatus in my laboratory.

In FIG. 1B, an alternative method of introducing the gas stream 7 to the reactor 8 is shown. This arrangement is reminiscent of, again, the laboratory pilot plant of one litre capacity, where in one mode the gas stream entered at the bottom of the liquid reaction mixture through a glass frit. The calculated reaction rates for the two modes of entry were sufficiently similar in this small volume to be ignored. But compared to the contemplated 0.178 cubic meters or 178 L in the commercial sized reactor, it can only be assumed that the extra complication of FIG. 1B and the gas injection perforated Teflon tube 9 will be preferred for continuous long term production of the two acids.

For best performance, the Teflon ring has graduated perforations, the smallest near the gas entrance and the largest just before the end of the ring. It is important that the gas entrance perforated ring 9 not be flooded. Flooding will occur if the perforations are too large and if the diameter of the ring is too high and of course if the gas pressure is not appropriate to the mixed acid depth and the dimensions of perforations and the ring 8. From this it can be argued that various lengths, sizes of perforations and gas pressure should be allowed for as the solid or gas feed source is varied, or a multiple push on Teflon fitting with suitable top cocks can best serve the process. Having the possibility of rapid change of tube would serve two uses; if the tube became largely blocked by solids not removed and if the feed to the burners were suddenly changed, changing the pressure in the reactor, to give minimum interruption to production.

Further, in the configuration of the invention shown in FIG. 1B the perforated Teflon coil 9 is supported above the bottom of the stirrer in the reactor 16 with the perforations on the bottom, so that any particulate matter would more likely be blown out by the gas. An accumulation of unwanted solids can be swept to the centre of the reactor to a finished acid exit port, not shown, allowing them to be removed in the normal way with the finished acid then separated by decantation.

In practice, the “finished acid” must be removed, or if not finished, removed to another stirred reactor. FIG. 1B does not show this. The laboratory tests showed that a second stirred reactor was un-necessary in a batch mode operation. It is easily visualized that should it be found expedient to have several stirred reactors in series when operating the invention in the continuous mode, that centre extraction of the mixed and enhanced acid and its addition to the top of a second stirred reactor would be effective.

Again in a batch mode use of the invention, as the feed gas made available neared its end, the rate of stirring could be reduced so that the heavier, more concentrated acid mixture would accumulate near the bottom, as noted in the charging of lead acid batteries (the so-called “layering effect”) and be drawn off leaving an effective starting mixture in the reactor in anticipation of another, batch mode run. A specially shaped reactor with a dished downward form with centre withdrawal port would be appropriate and in no way breach the invention principles.

In both modes, since the oxidation reactions occurring in the stirred reactor(s) are all exothermic, at least a stand-by heat extraction device such as an immersed Teflon or glass coated coil with a pumped liquid capable of extracting anticipated reaction heat must be provided.

What I claim is:

1-11. (canceled)

12. A method for using a mixture of nitric and sulfuric acid to form a homogenous catalytic solution of nitrosyl ion, a gas containing sulfur dioxide, nitrogen oxides and oxygen in ambient air where this gas mmixture is converted to both sulfuric and nitric acids when passed into a stirred reactor via reaction with the nitrosyl ion, the reduction products of the nitrosyl ion re-oxidized by the residual oxygen in the air or added oxygen, the gas being obtained from
a) sulfur burned in excess air or with extra oxygen at temperatures above 950 degrees Celcius to convert some of the nitrogen in the air to nitrogen oxides and
b) alternatively the feed to the burner is flue gas containing excess oxygen from the burning of an effluent gas from stored animal manure, landfill burnables or incineration of dried, powdered solid such as animal manure, sewage sludge or other waste material containing both sulfur and nitrogen compounds

13. The method according to claim 12, the burner may be a sulfur burner or a sulfur burner modified to burn dried, powdered solids at temperatures of 1100 degrees Celcius and higher containing sulfur and nitrogen

14. The method according to claim 12, where a high voltage produces a glow discharge in air gives more nitrogen oxides which are subsequently fed into the feed gas.

15. The method according to claim 12, an ammonia burner adds nitrogen oxides to the gas stream

16. The method according to claim 12, the cooled gas stream enters the stirred reactor through an inlet, and at about 80 degrees Celcius, and the reaction heat is removed by a heat exchanger to maintain the tempperatures at less than 80 C., as the reaction mixture is stirred by a magnetic stirring bar, at a rate sufficient raise the meniscus at least two centimeters above the centre

17. The method according to claim 12, the stirred reactor is acid resistant glass or is acid resistant, plastic-lined steel

18. The method according to claim 12, the starting acid concentrations may be as low as 0.1 M in sulfuric acid and less than one molar in nitric acid; the best starting concentrations are five and three molar respectively

19. The method according to claim 12, heat of reaction and from the burners is used to separate the two acids by distillation and to process them to the desired concentration, and to heat or dry the incoming waste material or air, or to co-generate electric power

20. The method according to claim 12 where more than one reactor is used, the reactors to be in series when more than one reactor is required to efficiently remove all of the SO2, NOx and heavy metals.

21. The method according to claim 12 when air is used as the oxidant, the remaining out-gas stream is almost pure nitrogen, which is compressed for sale using some if any co-generated electric power.

22. Heavy metals present in the fuel are first oxidized then precipitated as the sulfates in the strong sulfuric acid produced in both in the reaction vessel and in the still producing sulfuric acid for sale.
